(19) United States
(12) Patent Application Publication
(10) Pub. No.: US 2026/0353166 A1
(43) Pub. Date: Nov. 5, 2026

(54) RADIO FREQUENCY FRONT-END CONTROL USING GENERATIVE ARTIFICIAL INTELLIGENCE

(71) Applicant: QUALCOMM Incorporated, San Diego, CA (US)

(72) Inventors: Himanshu JOSHI, San Jose, CA (US); Rohit BHASI THAZHATH, San Diego, CA (US); Taesang YOO, San Diego, CA (US); Sandeep RAMANNAVAR, San Diego, CA (US); June NAMGOONG, San Diego, CA (US); Vinay CHANDE, San Diego, CA (US); Madhup CHANDRA, San Diego, CA (US)

(21) Appl. No.: 19/196,240

(22) Filed: May 1, 2025

(51) Int. Cl. H04W 28/02; H04L 41/16

(52) U.S. Cl. CPC H04W 28/0252; H04L 41/16

(57) ABSTRACT

This disclosure provides methods, components, devices and systems for radio frequency front-end (RFFE) control using generative artificial intelligence. For example,, a user equipment (UE) may obtain predicted traffic information from a machine learning model, and the UE may configure one or more front-end radio frequency components according to an adaptive power mode based on the predicted traffic information. The UE may input the predicted traffic information to an APM controller, and the APM controller may adapt the front-end radio frequency components accordingly. The machine learning model may be an example of UE-side foundational model (UEFM) trained on information that models a wireless protocol.

### TECHNICAL FIELD

This disclosure relates generally to wireless communication, and more specifically to systems, devices, methods, and techniques associated with radio frequency front-end (RFFE) control using generative artificial intelligence.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include inputting, to a machine learning model, configuration information associated with a wireless communications link, obtaining predictive traffic information as an output from the machine learning model, where the predictive traffic information is based on the machine learning model and the configuration information, adapting, in accordance with the predictive traffic information, a controller for one or more front-end radio frequency components of the UE, and receiving traffic via the one or more front-end radio frequency components in accordance with adaptation of the controller.

A UE for wireless communications is described. The UE may include a processing system that includes processor circuitry and memory circuitry that stores code. The processing system may be configured to cause the UE to input, to a machine learning model, configuration information associated with a wireless communications link, obtain predictive traffic information as an output from the machine learning model, where the predictive traffic information is based on the machine learning model and the configuration information, adapt, in accordance with the predictive traffic information, a controller for one or more front-end radio frequency components of the UE, and receive traffic via the one or more front-end radio frequency components in accordance with adaptation of the controller.

Another UE for wireless communications is described. The UE may include means for inputting, to a machine learning model, configuration information associated with a wireless communications link, means for obtaining predictive traffic information as an output from the machine learning model, where the predictive traffic information is based on the machine learning model and the configuration information, means for adapting, in accordance with the predictive traffic information, a controller for one or more front-end radio frequency components of the UE, and means for receiving traffic via the one or more front-end radio frequency components in accordance with adaptation of the controller.

A non-transitory computer-readable medium storing code for wireless communications is described. The code may include instructions executable by one or more processors to input, to a machine learning model, configuration information associated with a wireless communications link, obtain predictive traffic information as an output from the machine learning model, where the predictive traffic information is based on the machine learning model and the configuration information, adapt, in accordance with the predictive traffic information, a controller for one or more front-end radio frequency components of the UE, and receive traffic via the one or more front-end radio frequency components in accordance with adaptation of the controller.

In some examples of the method, UEs, and non-transitory computer-readable medium described herein, obtaining the predictive traffic information may include operations, features, means, or instructions for obtaining one or more of predictive grant arrival timing information, predictive grant rank information, predictive modulation and coding scheme (MCS) information, a predictive block error rate, a predictive change to an MCS, or a predictive change to rank information for the traffic.

In some examples of the method, user equipment (UEs), and non-transitory computer-readable medium described herein, adapting the controller for the one or more front-end radio frequency components may include operations, features, means, or instructions for adapting an analog-to-digital converter order, a bypass frequency dependent residual sideband block, an automatic gain control switch point, an automatic gain control step size, one or more receive antennas, a baseband filter linearity, or any combination thereof.

In some examples of the method, UEs, and non-transitory computer-readable medium described herein, receiving the traffic may include operations, features, means, or instructions for monitoring for one or more grants or grant bursts during a quantity of slots based on predictive timing information indicated by the predictive traffic information.

In some examples of the method, user equipment (UEs), and non-transitory computer-readable medium described herein, adapting the controller for the one or more front-end radio frequency components may include operations, features, means, or instructions for switching the one or more front-end radio frequency components to a high power mode or a low power mode based on the predictive traffic information.

### BRIEF DESCRIPTION OF THE DRAWINGS

FIG. 1 shows an example of a wireless communication system.

FIG. 2 shows an example of a signaling diagram that supports radio frequency front-end (RFFE) control using generative artificial intelligence.

FIG. 3 shows an example of an adaptive power mode (APM) configuration that supports RFFE control using generative artificial intelligence.

FIG. 4 shows an example of a process flow that supports RFFE control using generative artificial intelligence.

FIG. 5 shows a block diagram of a processing system that supports RFFE control using generative artificial intelligence.

FIG. 6 shows a diagram of a system including a device that supports RFFE control using generative artificial intelligence.

FIGS. 7 through 9 show flowcharts illustrating methods that support RFFE control using generative artificial intelligence.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may implement algorithms to adjust settings for a radio frequency front-end (RFFE) of the UE. The algorithms used to adjust RFFE settings, quantization, and/or step factors (e.g., power step factors) may be referred to as an adaptive power mode (APM). The algorithms for APM may be implemented based on or account for a state of the UE, ongoing procedures at the UE (e.g., current traffic conditions at the UE), historical traffic statistics, and expected types of traffic for the UE. An APM controller of the UE may adjust settings at the RFFE to optimize power draw at the RFFE based on these factors. For example, the APM may change to a low power mode if the UE expects physical downlink control channel (PDCCH) without a grant for physical downlink shared channel (PDSCH) or data traffic, and an APM controller of the UE may adjust the RFFE settings to lower power states. With average modeled traffic, the APM may change to a default power mode, and the APM controller may adjust the RFFE settings to be balanced between power savings and performance. If a grant or a burst of grants is detected, the APM may reactively change to a high power mode, and the APM controller may change settings at the RFFE of the UE to improve performance for high throughput (e.g., but with higher power draw). In some cases, APM algorithms may use past statistics collected over a predefined or preconfigured time window. The procedures used to analyze the past metrics and derive heuristic quantities may not be flexible enough for the variety of situations the UE may be in.

Aspects of the subject matter described in this disclosure relate to APM techniques based on prediction. For example, a UE may obtain predicted traffic characteristics from a machine learning model, and the UE may input the predicted traffic characteristics to an APM controller to implement APM algorithms. For example, the APM controller may adjust RFFE settings based on predicted traffic characteristics, current traffic characteristics, and historical traffic characteristics. The RFFE settings may include, for example, low noise amplifier (LNA) parameters, power amplifiers, automatic gain control (AGC) parameters, analog-to-digital (ADC) parameters, linearity filters, or any combination thereof. The machine learning model may be an example of a UE-side foundation model (UEFM), a generative AI-based foundation model, or a generative link model (GLM), or any combination thereof. In some examples, the UEFM may be a large language model that is trained on information that models a wireless protocol, such as a RAT the UE uses to communicate. For example, the UEFM may output when a grant is predicted to arrive at the UE and a predicted rank of the grant, and the UE may input the predicted grant arrival time and the predicted rank to the APM controller. The APM controller may configure the RFFE settings based on the predicted grant arrival time and the predicted rank. Additionally, or alternatively, the UEFM may output predictions of network-side parameters or predictions of traffic-level parameters, or both, such that the APM controller may adjust a configuration of the RFFE based on predictions of network-side information.

Particular aspects of the subject matter described in this disclosure can be implemented to realize one or more of the following potential advantages. In some examples, by adapting a controller of an RFFE of a UE based on predictive traffic information, the described techniques can be used to optimize power draw at the RFFE, for example by entering a lower-power mode if the UE is predicted to have little traffic or entering a higher-power mode if the UE is predicted to have heavy traffic.

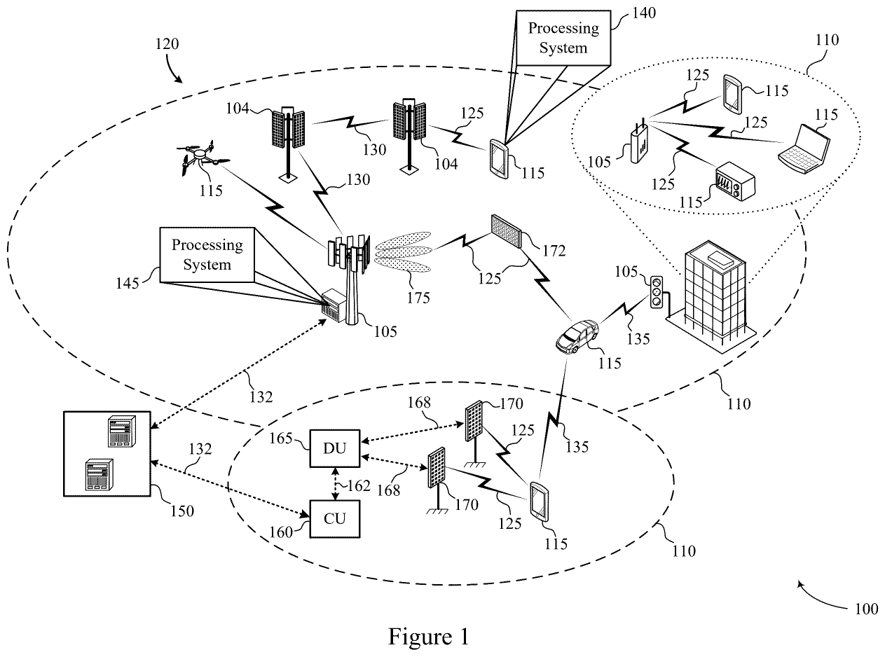

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

A UE 115 in the wireless communications system 100 may use specialized algorithms that adjust RFFE settings of the UE 115, quantization, and step factors. The algorithms, or the use of the algorithms to perform power adaptation, may be referred to as APM. The algorithms may consider a current state of the UE 115, procedures that are occurring at the UE 115, and expected traffic for the UE 115 to perform power adaptation. For example, APM may downgrade to a low power mode if the UE 115 expects only PDCCH (e.g., and not PDSCH or data traffic). With average modeled traffic, the UE 115 may move to a default power mode. When a burst (e.g., of traffic or a burst of grants) or a grant is detected and heavy traffic is arriving at the UE 115, an APM state machine may move to a higher power mode. In some wireless communications systems, the APM state machine may reactively move to the higher power mode based on detection of the grant or burst.

APM algorithms in some wireless communications systems may be based on rules-based heuristics and past statistics collected over a window. In these systems, the window and rules that determine operation of an APM state machine may be predefined and static. For example, the window and the rules for APM state machine operation may not be flexibly adaptable for different network, channel, or traffic conditions. For example, a size of a window for statistics collection may not be adjustable, and the APM state machine of these systems may only be operable based on historic and/or current conditions at the UE 115.

For example, decision indicators for an APM controller to select between a low power mode, a default power mode, and a higher power mode may rely on past data. APM may be initialized to a default power mode until the APM controller is provided a new metric for evaluating the APM. For example, previous link activity may be input to the APM controller, and the APM controller may select between the low power mode, the default power mode, and the higher power mode based on the link activity. Link activity may include, for example, downlink rank, modulation and coding scheme (MCS), a quantity of granted resource elements from a downlink grant, uplink channel state feedback (CSF) reports, discontinuous reception (DRX) state information, connected mode DRX (C-DRX) events, a size of a grant, HARQ feedback information, or any combination thereof, among others.

The wireless communication system 100 may support techniques for APM based on predictive information. For example, a UE 115 may provide predictive traffic information to an APM controller, and the APM controller may configure RFFE settings based on the predictive traffic information. For example, the APM controller may adjust radio components of the UE 115 to operate according to a low power mode, a default power mode, or a higher power mode based on prediction information. The UE 115 may obtain the prediction information from a machine learning model, such as a UEFM. The UEFM may use historical link activity to predict realistic future characteristics of traffic information or link activity. The UEFM may be pre-trained on a large amount of data obtained from simulations and commercial trials. In some examples, the UEFM may learn various distributions and relationships from data available at the UE 115, such as parameters of a network entity 105 that schedules the UE 115 or traffic-level parameters.

Devices of the wireless communication system 100 may be configured to support one or more aspects of the described techniques for RFFE control using generative artificial intelligence. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support improved throughput for a UE 115 and reduced power consumption at the UE 115.

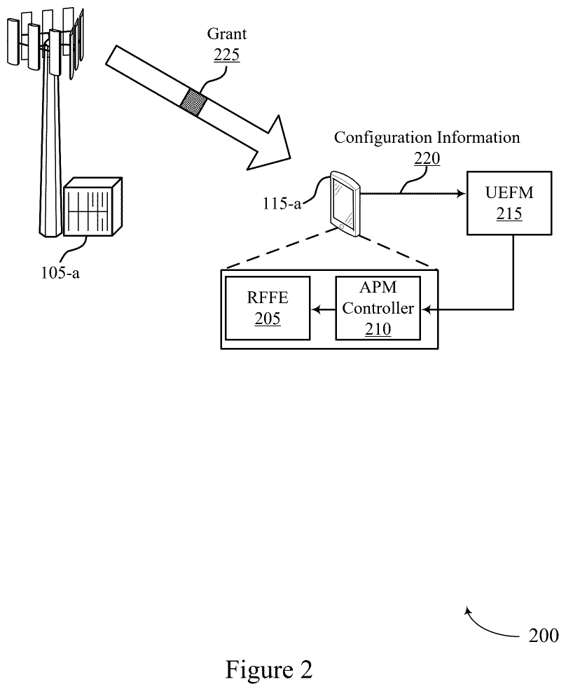

FIG. 2 shows an example of a signaling diagram 200 that supports RFFE control using generative artificial intelligence. The signaling diagram 200 may implement aspects of a wireless communication system 100. For example, the signaling diagram 200 may include a UE 115-a and a network entity 105-a, which may be respective examples of a UE 115 and a network entity 105 described herein.

The UE 115-a may support techniques for power adaptation, such as an APM. An RFFE 205 of the UE 115-a may be adjusted by an APM controller 210 based on inputs to the APM controller. The UE 115-a may support APM based on prediction information. For example, the UE 115-a may obtain predictive traffic information from a UEFM 215 and input the predictive traffic information to the APM controller 210. The APM controller 210 may adjust settings of the RFFE 205 based on the predictive traffic information.

The UEFM 215 may be an example of a large language model. For example, the UEFM 215 may be a foundational large language model deployed on the UE-side. Some parameters that determine the efficacy of UE-network entity link adaptation, and by extension the experienced quality of service (QoS) at the UE 115-a, may not be directly observed by the UE 115-a. For example, parameters of the network entity 105-a (e.g., which schedules the UE 115-a for communications), load information of the network entity 105-a, a presence of an outer-loop considered by the network entity 105-a for link adaptation, a presence of traffic, a class of traffic, and other such parameters may affect link adaptation between the UE 115-a and the network entity 105-a, but these parameters may not be directly observed by the UE 115-a. The UEFM 215 may be pre-trained on a large amount of data, which may be obtained from simulations or commercial trials, or both. The UEFM 215 may be trained to learn various distributions and relationships from data that is available at the UE 115-a. For example, the UEFM 215 may predict parameters of the network entity 105-a, traffic-level parameters, and other parameters that are not observed by the UE 115-a based on information that is available at the UE 115-a.

For example, the UEFM 215 may predict or simulate realistic future scenarios based on information for recent past scenarios. In some examples, prediction outputs may be input to the UEFM 215, such that historical information and hypothetical future information are input to the UEFM 215 to obtain statistics over subsequent desired outcomes or events. The UEFM 215 may operate on a token-by-token and/or slot-by-slot approach. A token may refer to an element corresponding to a signal, value, field, or any combination thereof, of UE and network entity interaction. Future prediction information or quantities, such as a predicted grant arrival time, predicted grant rank, predicted grant size, or predicted BLER, may be determined by generating a set of possible future outcomes and obtaining predicted statistics. In some examples, the UEFM 215 may predict periods where the UE 115-a can enter a sleep mode or a low power mode early.

In some examples, the UE 115-a may use the UEFM 215 to predict a realistic future grant arrival time, and the predicted grant arrival time may be input to the APM controller 210 to determine an APM. In some examples, the UE 115-a may use the UEFM 215 to predict a grant arrival time and a predicted rank of the grant or a corresponding predicted block error rate (BLER), or both. The predicted information may be input to the APM controller 210, and the APM controller 210 may adjust configurations at the RFFE 205 according to the prediction information.

In some examples, the UEFM 215 may predict grant information or grant burst information for the UE 115-a. For example, the UEFM 215 may predict a grant arrival time, grant sparsity, MCS, rank, or pass/failure for a grant. In some examples, the UEFM 215 may predict a burst or collection of grants for the UE 115-a. A burst of grants may be multiple grants that are close together in time (e.g., received at the UE 115-a within a threshold difference in time). The UEFM 215 may predict a burst arrival, an average spectral efficiency of the burst (e.g., based on MCS), or a burst duration, or any combination thereof. For example, the burst duration may correspond to an amount of time the RFFE 205 of the UE 115-a is to be active or in a higher-power state. In some examples, the UE 115-a may obtain an aggregated value for any one or more predictive parameters over one or several bursts or a duration of interest, or both. For example, the UEFM 215 may output predictive grant rank information, predictive MCS information, predictive BLER, predictive change to an MCS, predictive change to rank information, or any combination thereof, that is aggregated or averaged over one or several bursts of grants or time durations.

In some examples, the APM controller 210 may configure the RFFE 205 for lower-power settings according to the predictive traffic information. For example, based on a predicted BLR, a predicted rank indication, or other predicted state information, the APM may (e.g., opportunistically) choose to enter lower power states. For example, the APM may enter a low power mode, or the APM may enter a default power mode if the APM is currently operating in a high power mode. The APM may, for example, enter the lower power state if a predicted BLER is low, saving power at the UE 115-a due to reduced RFFE settings without impacting decoding performance. In some examples, the predictive traffic information may indicate that a grant is not predicted to arrive at the UE 115-a for a quantity of slots (e.g., for K slots), and the APM controller 210 may configure the APM to a low power mode or a lower-power state, adjusting settings of the RFFE 205 for the low power mode or lower-power state.

In some examples, the APM controller 210 may configure the RFFE 205 for higher-power settings according to the predictive traffic information. For example, if the predictive traffic information indicates a higher rank indicator than a rank currently configured for the UE 115-a, the APM may enter a higher-power state. For example, the APM controller 210 may configure the RFFE 205 for a high power mode, or the APM controller 210 may configure the RFFE 205 for a default power mode if the APM is current in a low power mode, improving decoding performance at the UE 115-a.

The UEFM 215 may output additional prediction information based on new inputs to the UEFM 215. For example, the UEFM 215 may output predicted MCS or rank changes in response to traffic patterns or changes to traffic patterns. For example, the UEFM 215 may iteratively output predictive traffic information based on input information and past predictions of the UEFM 215. The output of the UEFM 215 may be sampled to create future predicted token sequences.

The UE 115-a may prompt the UEFM 215 to obtain the predictive traffic information. Prompting may refer to providing a string of input to the UEFM 215, asking the UEFM 215 to generate a distribution over the next token or a set of next tokens in an autoregressive manner. For autoregressive generation, the UEFM 215 (e.g., when prompted) may generate a distribution over the next token. The UE 115-a or the UEFM 215, or both, may select the next token based on the distribution. The output token may be appended to the prompt, and the process may be repeated, using the output of one prompt as part of an input for a next prompt to the UEFM 215. For example, the output of the UEFM 215 may be fed back as an input in subsequent time steps for subsequent prompts.

In some examples, the UE 115-a may input configuration information 220 to the UEFM 215. For example, the UE 115-a may input current radio frequency channel conditions (e.g., signal-to-noise ratio (SNR) measurements, reference signal received quality (RSRQ) measurements, RSRP measurements, or historical measurement information for these metrics), historical or current grant information (e.g., a MCS information, spatial layer information, or rank information for a current grant or historical grants), a quantity of configured receive antenna elements, BLER information (e.g., residual BLER information), CSF reporting information (e.g., a channel quality indicator (CQI), a rank indicator (RI), or SRS), or any combination thereof, to the UEFM 215. In some examples, the UE 115-a may input network configuration information to the UEFM 215, such as carrier aggregation information, whether the network configuration is standalone or non-standalone, or a bandwidth of a serving cell provided by the network entity 105-a. In some examples, the UE 115-a may input historical grant information to the UEFM 215, such as grant sparsity over time. In some examples, the UE 115-a may input current data scheduling information (e.g., a data scheduling pattern), types of grants in use, or types of device applications in use to the UEFM 215. In some examples, the UE 115-a may input battery information, such as a current UE battery level or UE batter reserves information, to the UEFM 215. In some examples, the UE 115-a may input location information of the UE 115-a to the UEFM 215, such as a GPS location of the UE 115, daily user routine information, or travel map information. The UEFM 215 may generate the predictive traffic information based on the parameters.

In some examples, at least a portion of the configuration information 220 may additionally, or alternatively, be input to the APM controller 210. For example, the UE 115-a may input current radio frequency channel conditions (e.g., SNR measurements, RSRQ measurements, RSRP measurements, or historical measurement information for these metrics), historical or current grant information (e.g., a MCS information, spatial layer information, or rank information for a current grant or historical grants), a quantity of configured receive antenna elements, BLER information (e.g., residual BLER information), CSF reporting information (e.g., a CQI, an RI, or SRS), or any combination thereof, to the UEFM 215. In some examples, the UE 115-a may input network configuration information to the UEFM 215, such as carrier aggregation information, whether the network configuration is standalone or non-standalone, or a bandwidth of a serving cell provided by the network entity 105-a. In some examples, the UE 115-a may input historical grant information to the UEFM 215, such as grant sparsity over time. In some examples, the UE 115-a may input current data scheduling information (e.g., a data scheduling pattern), types of grants in use, or types of device applications in use to the UEFM 215. In some examples, the UE 115-a may input battery information, such as a current UE battery level or UE batter reserves information, to the UEFM 215. In some examples, the UE 115-a may input location information of the UE 115-a to the UEFM 215, such as a GPS location of the UE 115, daily user routine information, or travel map information. The UEFM 215 may generate the predictive traffic information based on the parameters.

Additionally, or alternatively, the UE 115-a may input these parameters to the APM controller 210. For example, the UE 115-a may input the current radio frequency channel conditions, grant information, receive antenna information, BLER information, CSF information, or any combination thereof, to the APM controller 210. In some examples, the UE 115-a may input network configuration information, grant history information, scheduling pattern information, grant type information, device application information, battery information, or location information, or any combination thereof, to the APM controller 210. The APM controller 210 may adjust the RFFE 205 or change the APM based on the parameters.

The APM controller 210 may adjust an APM of the UE 115-a based on the predictive traffic information. For example, the APM controller 210 may adjust settings of the RFFE 205 based on the predictive traffic information from the UEFM 215, parameters input by the UE 115-a, or both. The APM controller 210, in some examples referred to as an APM state controller, may adjust UE antenna configurations and settings to toggle between power and performance. For example, higher performance settings for weak channel or high grant traffic may correspond to lower power efficiency or vice versa. The RFFE settings (e.g., adjusted or configured by the APM controller 210) may include an ADC order, bypass frequency dependent residual side band blocks, AGC switch points, baseband filter linearity, or any combination thereof. The RFFE settings may be configured to optimize RFFE power draw, for example based on the predictive traffic information, historical traffic information, current configurations of the UE 115-a, or any combination thereof.

For example, the UE 115-a may input the configuration information 220 to the UEFM 215, and the UEFM 215 may provide an output including predictive traffic information. The predictive traffic information may, for example, indicate predicted timing information for a grant 225 or a burst of grants from the network entity 105-a. The UE 115-a may input the predictive traffic information to the APM controller 210. In some examples, the UE 115-a may input some or all of the configuration information 220 to the APM controller 210. The APM controller 210 may adjust an APM of the UE 115-a according to the predictive traffic information. In some examples, the predictive traffic information may indicate that the network entity 105-a is predicted to transmit a grant 225 or a burst of grants to the UE 115-a within a threshold quantity of slots, and the APM controller 210 may adjust settings of the RFFE 205 to a higher-power state (e.g., a high power mode). In some other examples, the predictive traffic information may indicate that the network entity 105-a is not predicted to transmit a grant to the UE 115-a within a threshold quantity of slots, and the APM controller 210 may adjust settings of the RFFE 205 to a lower-power state (e.g., a low power mode).

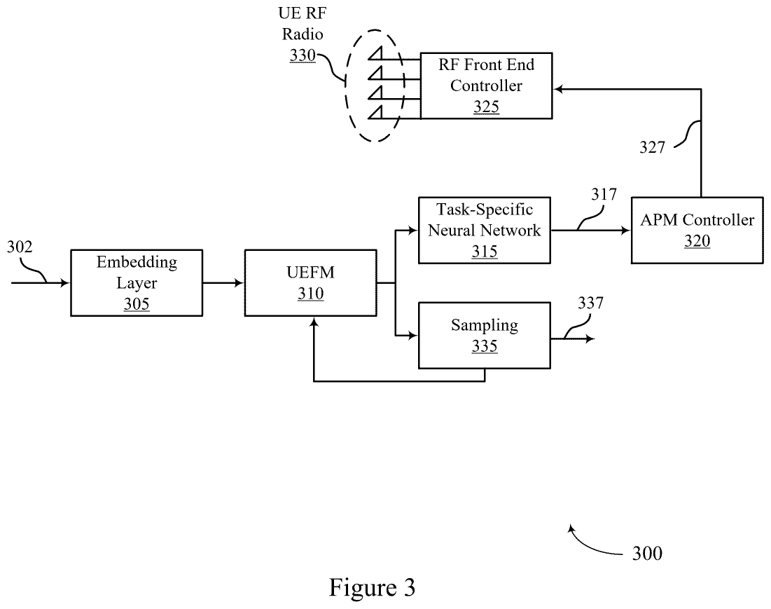

FIG. 3 shows an example of an APM configuration 300 that supports RFFE control using generative artificial intelligence. In some examples, a UE 115 may implement the APM configuration 300. For example, the UE 115 may use a UEFM 310 to obtain predictive traffic information, and the predictive traffic information may be used as an input for an APM algorithm described herein.

In some examples, the UE 115-a may use an embedding of a UEFM 310 to obtain predictive traffic information. For example, the UE 115-a may communicate with the UEFM 310 via an embedding layer 305. The UE 115-a may input configuration information 302 to the UEFM 310 via the embedding layer. For example, the UE 115-a may input information from past link level activity or hypothetical future link-level activity to the embedding layer, and the embedding layer may input the past or hypothetical link-level activity to the UEFM 310. In some examples, the UE 115 may input additional parameters to the UEFM 310, such as channel condition information, grant information, a quantity of configured receive antennas of the UE 115, block error rate information, channel state feedback reporting information, UE-side settings, UE-side configurations, UE-side parameters, implicit network-side parameters determined based on communications with a network entity 105, or any combination thereof.

The UEFM 310 may output predictive traffic information based on the configuration information as input. The UEFM may output predictive information for metrics which impact downlink traffic decoding at a UE 115, such as predictive channel conditions. In some examples, the UEFM 310 may output predicted traffic information for slot N+1, such as predicted grant information or predicted channel characteristics. In some examples, to predict a future N+1th slot, the UEFM 310 may use an input prompt and past predictions from the UEFM 310. In some examples, the UEFM 310 may output predicted timing information for a grant or a burst of grants. The UEFM 310 may output a predicted MCS, predicted BLR, predicted granted allocation size, grant sparsity, or predicted spatial layers associated with the predicted grant or predicted burst of grants.

In some examples, the UEFM 310 may send the predictive traffic information to a task-specific neural network 315. The task-specific neural network 315 may be a neural network layer added on top of the UEFM 310 to predict a quantity of interest other than a next token (e.g., for autoregressive generation). For example, the task-specific neural network 315 may output a power mode classifier 317 for APM based on the output of the UEFM 310 (e.g., the predictive traffic information). The task-specific neural network 315 may send the power mode classifier 317 to an APM controller 320.

The APM controller 320 may change an APM of the UE 115 based on the power mode classifier 317. For example, the APM controller 320 may change the APM of the UE 115 to a power mode that is based on the predictive traffic information output from the UEFM 310. In some examples, the APM controller 320 may send a configuring signal 327 to an RFFE controller 325 of the UE 115 to change the APM to a default power mode based on the power mode classifier 317. In some examples, the APM controller 320 may send a configuring signal to an RFFE controller 325 of the UE 115 to change the APM to a high power mode based on the power mode classifier 317. In some examples, the APM controller 320 may send a configuring signal to an RFFE controller 325 of the UE 115 to change the APM to a low power mode based on the power mode classifier 317.

The RFFE controller 325 may adapt a configuration of a UE RF radio 330 based on the APM. In some examples, the UE 115 (e.g., via the RFFE controller 325) may adapt an ADC order, a bypass frequency dependent residual sideband block, an AGC switch point, an AGC step size, one or more receive antennas, a baseband filter linearity, or any combination thereof, in accordance with the selected mode.

In some examples, the output of the UEFM 310 may be used as an input for later predictions. For example, the output of the UEFM 310 may be sampled by a sampling block 335. The sampling block 335 may output a future predicted token sequence 337 based on the output of the UEFM 310. For example, the future predicted token sequence may be input to the UEFM 310 as part of a next prompt to obtain future predictive traffic information.

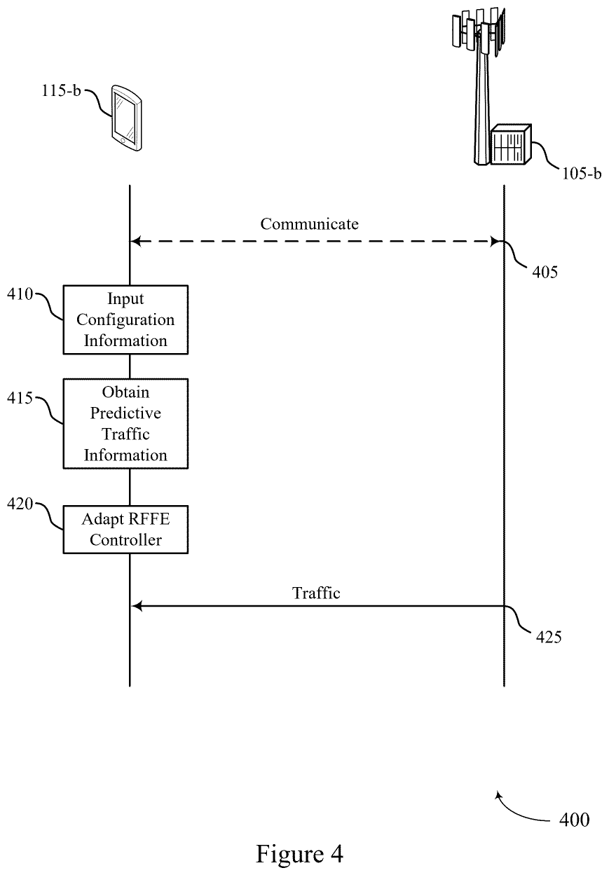

FIG. 4 shows an example of a process flow 400 that supports RFFE control using generative artificial intelligence. The process flow 400 may include aspects of a wireless communication system 100, a signaling diagram 200, an APM configuration 300, or any combination thereof. For example, the process flow 400 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 400, some aspects of some operations may also be performed by one or more other wireless devices.

In some examples, the UE 115-b and the network entity 105-b may communicate over a wireless communications link at 505. The UE 115-b may support an APM based on prediction information, such as predictive traffic information for the wireless communications link.

At 410, the UE 115-b may input, to a machine learning model, configuration information associated with the wireless communications link. The machine learning model may include aspects of a large language model. For example, a UEFM described herein may be an example of the machine learning model. In some examples, the machine learning model may be stored at the UE 115-b. In some other examples, the machine learning model may be stored separate from the UE 115-b, such as on a server. In some examples, the UE 115-b may output information to or receive information from the machine learning model via an embedding layer. For example, the configuration information may be input to the machine learning model as part of a prompt to the machine learning model.

In some examples, the configuration information may include information for past link-level activity or configurations of the UE 115-b, or both. The configuration information may include channel condition information, grant information, a quantity of configured receive antennas of the UE 115-b, block error rate information, channel state feedback reporting information, UE-side settings, UE-side configurations, UE-side parameters, implicit network-side parameters determined based on communications with the network entity 105-b, or any combination thereof. The channel condition information may include one or more historical SNRs, one or more historical RSRQ measurements, one or more historical RSRP measurements, or any combination thereof.

The UE 115-b may obtain predictive traffic information as an output from the machine learning model. The predictive traffic information may be based on the machine learning model and the configuration information. For example, the machine learning model may be trained on a large set of training data, and the machine learning model may output prediction information based on the input from the UE 115-b and the training data to predict future traffic scenarios or future traffic information for the UE 115-b.

In some examples, prediction information may be used as part of an input to the machine learning model. For example, the machine learning model may output first predictive information based on a first prompt to the machine learning model. The first predictive information may be used as part of a second prompt to the machine learning model, and the machine learning model may output second predictive information based on the second prompt to the machine learning model.

At 420, the UE 115-b may adapt, in accordance with the predictive traffic information, a controller for one or more front-end radio frequency components of the UE 115-b. For example, the UE 115-b may adapt an ADC order, a bypass frequency dependent residual sideband bock, an AGC switch point, an AGC step size, one or more receive antennas, a baseband filter linearity, or any combination thereof. Adapting the controller for the one or more front-end radio frequency components may include, for example, setting the APM to a low power mode, a default power mode, or a high power mode, or a combination thereof. For example, the UE 115-b may switch the one or more front-end radio frequency components to a high power mode or a low power mode based on the predictive traffic information.

At 425, the UE 115-b may receive traffic via the one or more front-end radio frequency components in accordance with adaptation of the controller. For example, the UE 115-b may monitor for one or more grants or grant bursts during a quantity of slots based on predictive timing information indicated by the predictive traffic information. In some other examples, the predictive traffic information may indicate that the UE 115-b is not to receive a grant or a grant burst within a next K slots, and the UE 115-b may enter a low power mode based on the predictive traffic information.

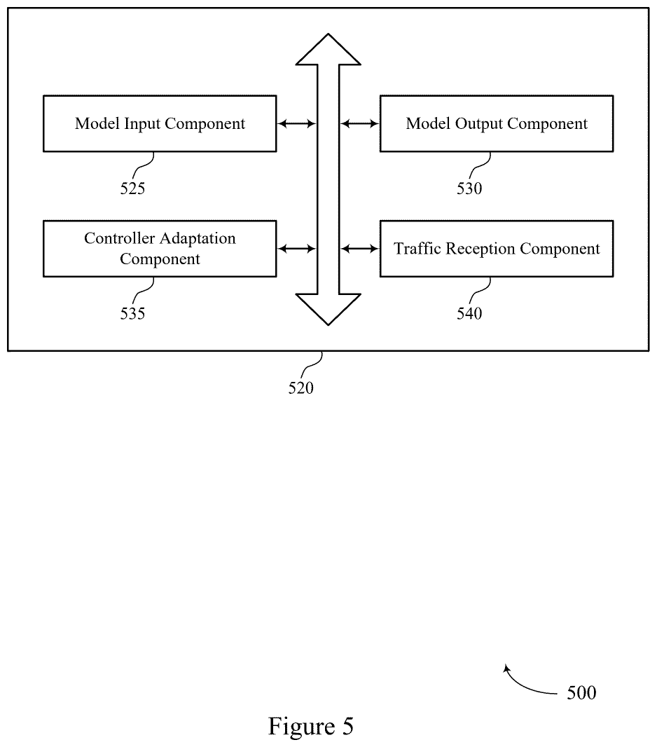

FIG. 5 shows an example 500 of a processing system 520 that supports RFFE control using generative artificial intelligence. A processing system 520 may be an example of a processing system 140 (such as of a UE 115) and may include a model input component 525, a model output component 530, a controller adaptation component 535, a traffic reception component 540, or any combination thereof. A processing system 520, or various component thereof, may be an example of means for performing (such as a means for causing a UE 115 to perform) various techniques described herein.

The model input component 525 may be configured to cause the UE 115 to input, to a machine learning model, configuration information associated with a wireless communications link. The model output component 530 may be configured to cause the UE 115 to obtain predictive traffic information as an output from the machine learning model, where the predictive traffic information is based on the machine learning model and the configuration information. The controller adaptation component 535 may be configured to cause the UE 115 to adapt, in accordance with the predictive traffic information, a controller for one or more front-end radio frequency components of the UE. The traffic reception component 540 may be configured to cause the UE 115 to receive traffic via the one or more front-end radio frequency components in accordance with adaptation of the controller.

In some examples, to support obtaining the predictive traffic information, the model output component 530 may be configured to cause the UE 115 to obtain one or more of predictive grant arrival timing information, predictive grant rank information, predictive MCS information, a predictive grant sparsity, a predictive period for entering a low power mode, a predictive block error rate, a predictive change to an MCS, or a predictive change to rank information for the traffic. In some examples, the predictive grant arrival timing information, the predictive grant rank information, the predictive MCS information, the predictive block error rate, the predictive change to the MCS, the predictive grant sparsity, the predictive period for entering a low power mode, or the predictive change to rank information for the traffic, or any combination thereof, are aggregated over one or more bursts of grants or time durations, or both.

In some examples, to support adapting the controller for the one or more front-end radio frequency components, the controller adaptation component 535 may be configured to cause the UE 115 to adapt an analog-to-digital converter order, a bypass frequency dependent residual sideband block, an automatic gain control switch point, an automatic gain control step size, one or more receive antennas, a baseband filter linearity, or any combination thereof.

In some examples, to support receiving the traffic, the traffic reception component 540 may be configured to cause the UE 115 to monitor for one or more grants or grant bursts during a quantity of slots based on predictive timing information indicated by the predictive traffic information.

In some examples, to support adapting the controller for the one or more front-end radio frequency components, the controller adaptation component 535 may be configured to cause the UE 115 to switch the one or more front-end radio frequency components to a high power mode or a low power mode based on the predictive traffic information.

In some examples, to support obtaining the predictive traffic information, the model output component 530 may be configured to cause the UE 115 to obtain an indication that one or more grants or grant bursts are predicted to arrive at the UE within a threshold quantity of slots.

In some examples, the configuration information associated with the wireless communications link includes channel condition information, grant information, a quantity of configured receive antennas of the UE, block error rate information, channel state feedback reporting information, UE-side settings, UE-side configurations, UE-side parameters, implicit network-side parameters determined based on communications with a network entity, or any combination thereof.

In some examples, the channel condition information includes one or more historical signal-to-noise ratios, one or more historical reference signal received quality measurements, one or more historical reference signal received power measurements, or any combination thereof.

In some examples, the controller for the one or more front-end radio frequency components is adapted based on network configuration information, grant history information, current data scheduling information, a battery level of the UE, a location of the UE, or any combination thereof.

In some examples, the model input component 525 may be configured to cause the UE 115 to input, to the machine learning model, additional configuration information obtained from receiving the traffic according to the adaptation of the controller for the one or more front-end radio frequency components.

In some examples, the predictive traffic information is based on an input of network-side scheduling information or network-side radio frame pattern information, or both.

In some examples, the machine learning model is a generative link model.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for improved communication reliability, improved user experience related to reduced processing, reduced power consumption, and improved coordination between devices.

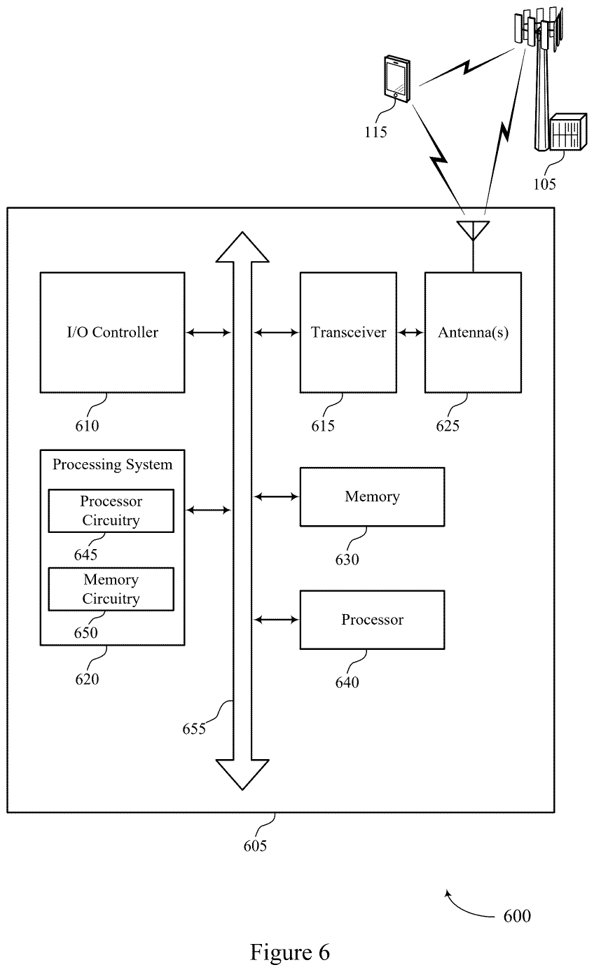

FIG. 6 shows an example of a system 600 including a device 605 that supports RFFE control using generative artificial intelligence. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, ADCs, and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support RFFE control using generative artificial intelligence. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved communication reliability, improved user experience related to reduced processing, reduced power consumption, and improved coordination between devices.

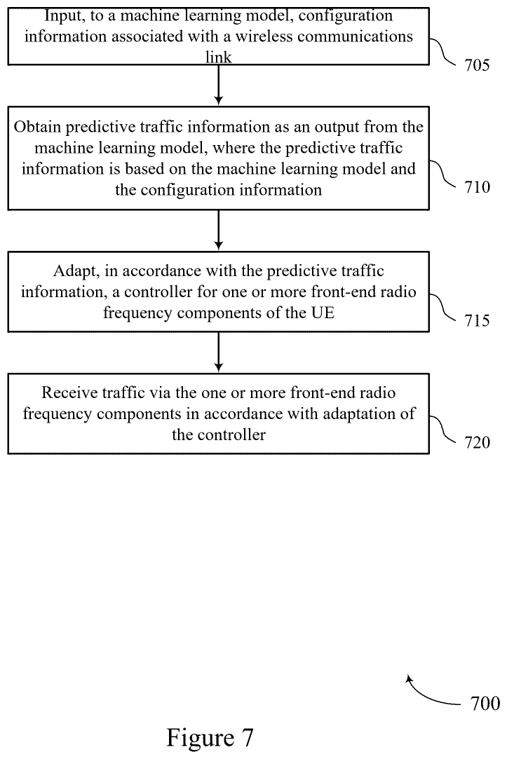

FIG. 7 shows an example of a method 700 that supports RFFE control using generative artificial intelligence. Operations of the method 700 may be performed by a UE or its components (such as using a processing system configured to cause the UE 115 to perform one or more of the operations) as described herein.

At 705, the method may include inputting, to a machine learning model, configuration information associated with a wireless communications link. In some examples, aspects of the operations of 705 may be performed by a model input component 525.

At 710, the method may include obtaining predictive traffic information as an output from the machine learning model, where the predictive traffic information is based on the machine learning model and the configuration information. In some examples, aspects of the operations of 710 may be performed by a model output component 530.

At 715, the method may include adapting, in accordance with the predictive traffic information, a controller for one or more front-end radio frequency components of the UE. In some examples, aspects of the operations of 715 may be performed by a controller adaptation component 535.

At 720, the method may include receiving traffic via the one or more front-end radio frequency components in accordance with adaptation of the controller. In some examples, aspects of the operations of 720 may be performed by a traffic reception component 540.

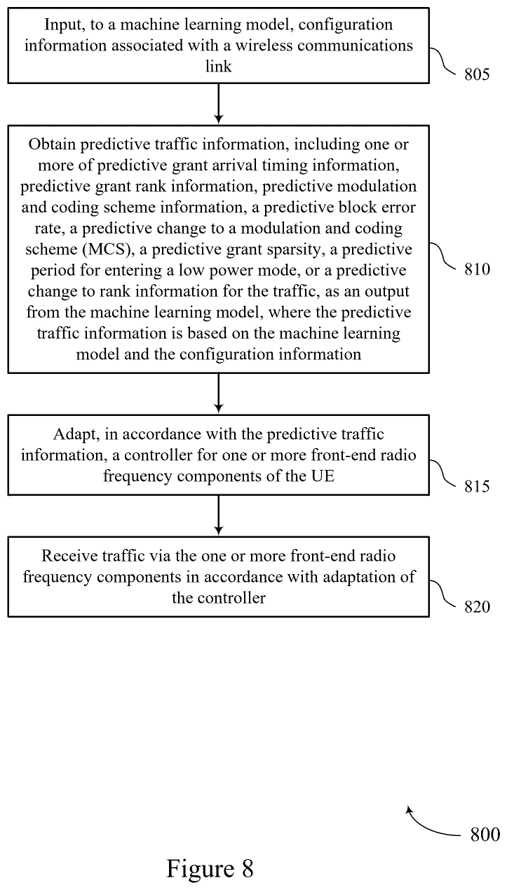

FIG. 8 shows an example of a method 800 that supports RFFE control using generative artificial intelligence. Operations of the method 800 may be performed by a UE or its components (such as using a processing system configured to cause the UE 115 to perform one or more of the operations) as described herein.

At 805, the method may include inputting, to a machine learning model, configuration information associated with a wireless communications link. In some examples, aspects of the operations of 805 may be performed by a model input component 525.

At 810, the method may include obtaining predictive traffic information, including one or more of predictive grant arrival timing information, predictive grant rank information, predictive MCS information, a predictive block error rate, a predictive change to an MCS, a predictive grant sparsity, a predictive period for entering a low power mode, or a predictive change to rank information for the traffic, as an output from the machine learning model, where the predictive traffic information is based on the machine learning model and the configuration information. In some examples, aspects of the operations of 810 may be performed by a model output component 530.

At 815, the method may include adapting, in accordance with the predictive traffic information, a controller for one or more front-end radio frequency components of the UE. In some examples, aspects of the operations of 815 may be performed by a controller adaptation component 535.

At 820, the method may include receiving traffic via the one or more front-end radio frequency components in accordance with adaptation of the controller. In some examples, aspects of the operations of 820 may be performed by a traffic reception component 540.

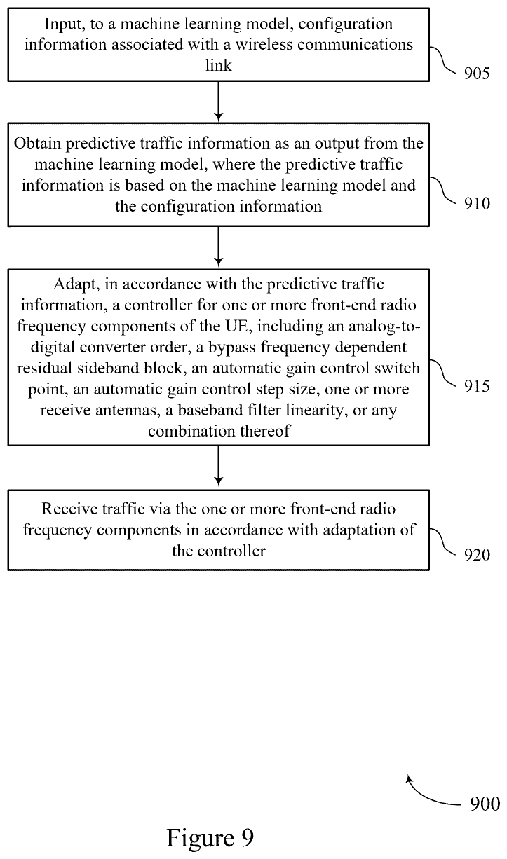

FIG. 9 shows an example of a method 900 that supports RFFE control using generative artificial intelligence. Operations of the method 900 may be performed by a UE or its components (such as using a processing system configured to cause the UE 115 to perform one or more of the operations) as described herein.

At 905, the method may include inputting, to a machine learning model, configuration information associated with a wireless communications link. In some examples, aspects of the operations of 905 may be performed by a model input component 525.

At 910, the method may include obtaining predictive traffic information as an output from the machine learning model, where the predictive traffic information is based on the machine learning model and the configuration information. In some examples, aspects of the operations of 910 may be performed by a model output component 530.

At 915, the method may include adapting, in accordance with the predictive traffic information, a controller for one or more front-end radio frequency components of the UE, including an analog-to-digital converter order, a bypass frequency dependent residual sideband block, an automatic gain control switch point, an automatic gain control step size, one or more receive antennas, a baseband filter linearity, or any combination thereof. In some examples, aspects of the operations of 915 may be performed by a controller adaptation component 535.

At 920, the method may include receiving traffic via the one or more front-end radio frequency components in accordance with adaptation of the controller. In some examples, aspects of the operations of 920 may be performed by a traffic reception component 540.

Implementation examples are described in the following numbered clauses:

Aspect 1: A method for wireless communications at a UE, comprising: inputting, to a machine learning model, configuration information associated with a wireless communications link; obtaining predictive traffic information as an output from the machine learning model, wherein the predictive traffic information is based at least in part on the machine learning model and the configuration information; adapting, in accordance with the predictive traffic information, a controller for one or more front-end radio frequency components of the UE; and receiving traffic via the one or more front-end radio frequency components in accordance with adaptation of the controller.

Aspect 2: The method of aspect 1, wherein obtaining the predictive traffic information comprises: obtaining one or more of predictive grant arrival timing information, predictive grant rank information, predictive MCS information, a predictive block error rate, a predictive grant sparsity, a predictive period for entering a low power mode, a predictive change to an MCS, or a predictive change to rank information for the traffic.

Aspect 3: The method of any of aspects 1 through 2, wherein the predictive grant arrival timing information, the predictive grant rank information, the predictive MCS information, the predictive block error rate, the predictive change to the MCS, the predictive grant sparsity, the predictive period for entering a low power mode, or the predictive change to rank information for the traffic, or any combination thereof, are aggregated over one or more bursts of grants or time durations, or both.

Aspect 4: The method of any of aspects 1 through 3, wherein adapting the controller for the one or more front-end radio frequency components comprises: adapting an analog-to-digital converter order, a bypass frequency dependent residual sideband block, an automatic gain control switch point, an automatic gain control step size, one or more receive antennas, a baseband filter linearity, or any combination thereof.

Aspect 5: The method of any of aspects 1 through 4, wherein receiving the traffic comprises: monitoring for one or more grants or grant bursts during a quantity of slots based at least in part on predictive timing information indicated by the predictive traffic information.

Aspect 6: The method of any of aspects 1 through 5, wherein adapting the controller for the one or more front-end radio frequency components comprises: switching the one or more front-end radio frequency components to a high power mode or a low power mode based at least in part on the predictive traffic information.

Aspect 7: The method of any of aspects 1 through 6, wherein obtaining the predictive traffic information comprises: obtaining an indication that one or more grants or grant bursts are predicted to arrive at the UE within a threshold quantity of slots.

Aspect 8: The method of any of aspects 1 through 7, wherein the configuration information associated with the wireless communications link comprises channel condition information, grant information, a quantity of configured receive antennas of the UE, block error rate information, channel state feedback reporting information, UE-side settings, UE-side configurations, UE-side parameters, implicit network-side parameters determined based at least in part on communications with a network entity, or any combination thereof.

Aspect 9: The method of aspect 8, wherein the channel condition information comprises one or more historical signal-to-noise ratios, one or more historical reference signal received quality measurements, one or more historical reference signal received power measurements, or any combination thereof.

Aspect 10: The method of any of aspects 1 through 9, wherein the controller for the one or more front-end radio frequency components is adapted based at least in part on network configuration information, grant history information, current data scheduling information, a battery level of the UE, a location of the UE, or any combination thereof.

Aspect 11: The method of any of aspects 1 through 10, further comprising: inputting, to the machine learning model, additional configuration information obtained from receiving the traffic according to the adaptation of the controller for the one or more front-end radio frequency components.

Aspect 12: The method of any of aspects 1 through 11, wherein the predictive traffic information is based at least in part on an input of network-side scheduling information or network-side radio frame pattern information, or both.

Aspect 13: The method of any of aspects 1 through 12, wherein the machine learning model is a generative link model.

Aspect 14: A UE for wireless communications, comprising a processing system that includes processor circuitry and memory circuitry that stores code, the processing system configured to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, ADCs, or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
input, to a machine learning model, configuration information associated with a wireless communications link;
obtain predictive traffic information as an output from the machine learning model, wherein the predictive traffic information is based at least in part on the machine learning model and the configuration information;
adapt, in accordance with the predictive traffic information, a controller for one or more front-end radio frequency components of the UE; and
receive traffic via the one or more front-end radio frequency components in accordance with adaptation of the controller.

2. The UE of claim 1, wherein, to obtain the predictive traffic information, the processing system is configured to cause the UE to:
obtain one or more of predictive grant arrival timing information, predictive grant rank information, predictive modulation and coding scheme (MCS) information, a predictive block error rate, a predictive change to an MCS, a predictive grant sparsity, a predictive period for entering a low power mode, or a predictive change to rank information for the traffic.

3. The UE of claim 1, wherein the predictive grant arrival timing information, the predictive grant rank information, the predictive MCS information, the predictive block error rate, the predictive change to the MCS, the predictive grant sparsity, the predictive period for entering a low power mode, or the predictive change to rank information for the traffic, or any combination thereof, are aggregated over one or more bursts of grants or time durations, or both.

4. The UE of claim 1, wherein, to adapt the controller for the one or more front-end radio frequency components, the processing system is configured to cause the UE to:
adapt an analog-to-digital converter order, a bypass frequency dependent residual sideband block, an automatic gain control switch point, an automatic gain control step size, one or more receive antennas, a baseband filter linearity, or any combination thereof.

5. The UE of claim 1, wherein, to receive the traffic, the processing system is configured to cause the UE to:
monitor for one or more grants or grant bursts during a quantity of slots based at least in part on predictive timing information indicated by the predictive traffic information.

6. The UE of claim 1, wherein, to adapt the controller for the one or more front-end radio frequency components, the processing system is configured to cause the UE to:
switch the one or more front-end radio frequency components to a high power mode or a low power mode based at least in part on the predictive traffic information.

7. The UE of claim 1, wherein, to obtain the predictive traffic information, the processing system is configured to cause the UE to:
obtain an indication that one or more grants or grant bursts are predicted to arrive at the UE within a threshold quantity of slots.

8. The UE of claim 1, wherein the configuration information associated with the wireless communications link comprises channel condition information, grant information, a quantity of configured receive antennas of the UE, block error rate information, channel state feedback reporting information, UE-side settings, UE-side configurations, UE-side parameters, implicit network-side parameters determined based at least in part on communications with a network entity, or any combination thereof.

9. The UE of claim 8, wherein the channel condition information comprises one or more historical signal-to-noise ratios, one or more historical reference signal received quality measurements, one or more historical reference signal received power measurements, or any combination thereof.

10. The UE of claim 1, wherein the controller for the one or more front-end radio frequency components is adapted based at least in part on network configuration information, grant history information, current data scheduling information, a battery level of the UE, a location of the UE, or any combination thereof.

11. The UE of claim 1, wherein the processing system is further configured to cause the UE to:
input, to the machine learning model, additional configuration information obtained from receiving the traffic according to the adaptation of the controller for the one or more front-end radio frequency components.

12. The UE of claim 1, wherein the predictive traffic information is based at least in part on an input of network-side scheduling information or network-side radio frame pattern information, or both.

13. The UE of claim 1, wherein the machine learning model is a generative link model.

14. A method for wireless communications at a user equipment (UE), comprising:
inputting, to a machine learning model, configuration information associated with a wireless communications link;
obtaining predictive traffic information as an output from the machine learning model, wherein the predictive traffic information is based at least in part on the machine learning model and the configuration information;
adapting, in accordance with the predictive traffic information, a controller for one or more front-end radio frequency components of the UE; and
receiving traffic via the one or more front-end radio frequency components in accordance with adaptation of the controller.

15. The method of claim 14, wherein obtaining the predictive traffic information comprises:
obtaining one or more of predictive grant arrival timing information, predictive grant rank information, predictive modulation and coding scheme information, a predictive block error rate, a predictive change to a modulation and coding scheme (MCS), or a predictive change to rank information for the traffic.

16. The method of claim 14, wherein adapting the controller for the one or more front-end radio frequency components comprises:
adapting an analog-to-digital converter order, a bypass frequency dependent residual sideband block, an automatic gain control switch point, an automatic gain control step size, one or more receive antennas, a baseband filter linearity, or any combination thereof.

17. The method of claim 14, wherein receiving the traffic comprises:
monitoring for one or more grants or grant bursts during a quantity of slots based at least in part on predictive timing information indicated by the predictive traffic information.

18. The method of claim 14, wherein adapting the controller for the one or more front-end radio frequency components comprises:
switching the one or more front-end radio frequency components to a high power mode or a low power mode based at least in part on the predictive traffic information.

19. The method of claim 14, wherein obtaining the predictive traffic information comprises:
obtaining an indication that one or more grants or grant bursts are predicted to arrive at the UE within a threshold quantity of slots.

20. A non-transitory computer-readable medium storing code for wireless communications at a user equipment (UE), the code comprising instructions executable by one or more processors to:
input, to a machine learning model, configuration information associated with a wireless communications link;
obtain predictive traffic information as an output from the machine learning model, wherein the predictive traffic information is based at least in part on the machine learning model and the configuration information;
adapt, in accordance with the predictive traffic information, a controller for one or more front-end radio frequency components of the UE; and
receive traffic via the one or more front-end radio frequency components in accordance with adaptation of the controller.
